(19) United States
(12) Patent Application Publication
(10) Pub. No.: US 2023/0344593 A1
(43) Pub. Date: Oct. 26, 2023

(54) APPARATUS AND METHOD FOR BEAM MANAGEMENT IN A MULTI-BEAM SYSTEM

(71) Applicant: MediaTek INC., Hsin-Chu (TW)

(72) Inventor: CHENG-RUNG TSAI, Hsin-Chu (TW)

(21) Appl. No.: 18/214,201

(22) Filed: Jun. 26, 2023

Related U.S. Application Data
(63) Continuation of application No. PCT/CN22/70656, filed on Jan. 7, 2022.
(60) Provisional application No. 63/134,601, filed on Jan. 7, 2021.
(60) Provisional application No. 63/215,560, filed on Jun. 28, 2021.
(60) Provisional application No. 63/250,289, filed on Sep. 30, 2021.

(51) Int. Cl. H04L 5/00; H04W 72/232; H04W 16/28

(52) U.S. Cl. CPC H04L 5/0051; H04W 72/232; H04W 16/28; H04L 5/0053

(57) ABSTRACT

Apparatus and methods are provided for beam management in a multi-beam system. In particular, a UE performs measurement on a set of RS resources, wherein each RS resource is associated with a TCI state. Then, the UE reports at least one RS resource of the set of RS resources or at least one TCI state associated with the at least one RS resource in a reporting instance to a network node. The UE receives a response from the network node in response to the reporting instance, and then applies the at least one RS resource or the at least one TCI state to downlink reception or uplink transmission.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2022/070656, with an international filing date of Jan. 7, 2022, which in turn claims priority from U.S. Provisional Application No. 63/134,601, entitled “Mobility in Multi-Beam System,” filed on Jan. 7, 2021; U.S. Provisional Application No. 63/215,560, entitled “Mobility in Multi-Beam System,” filed on Jun. 28, 2021; and U.S. Provisional Application No. 63/250,289, entitled “Mobility in Multi-Beam System,” filed on Sep. 30, 2021. This application is a continuation of International Application No. PCT/CN2022/070656, which claims priority from U.S. provisional applications 63/134,601, 63/215,560, and 63/250,289. International Application No. PCT/CN2022/070656 is pending as of the filing date of this application, and the United States is a designated state in International Application No. PCT/CN2022/070656. The disclosure of each of the foregoing documents is incorporated herein by reference.

### TECHNICAL FIELD

The disclosed embodiments relate generally to wireless communication, and, more particularly, to beam management in a multi-beam system.

### BACKGROUND

In conventional network of 3rd generation partnership project (3GPP) 5G new radio (NR), the user equipment (UE) may perform a legacy beam management procedure with the base station (BS) for determining beam(s) between the UE and the BS.

During the legacy beam management procedure, the UE may measure beam(s) or reference signal (RS) resource(s), and report the measurement to the BS. Then, the UE needs to wait for a beam activation transmitted from the BS so that the UE can apply the beam(s) or RS resource(s) for transmission. However, a significant beam activation latency may be produced in the legacy beam management procedure because the UE needs to wait for the beam activation from the BS.

### SUMMARY

Apparatus and methods are provided for beam management in a multi-beam system. In one novel aspect, a user equipment (UE) may apply beam(s) or reference signal (RS) resource(s) to transmission (e.g., downlink (DL) transmission, uplink (UL) transmission or both of DL and UL transmissions) without beam activation transmitted from a network node.

In particular, a UE performs measurement on a set of RS resources, wherein each RS resource is associated with a transmission configuration indication (TCI) state. Then, the UE reports at least one RS resource of the set of RS resources or at least one TCI state associated with the at least one RS resource in a reporting instance to a network node. The UE receives a response from the network node in response to the reporting instance, and then applies the at least one RS resource or the at least one TCI state to downlink reception or uplink transmission.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G new radio network supporting application of TCI state activation to reference signal in accordance with embodiments of the current invention.

FIG. 2 is a simplified block diagram of the gNB and the UE in accordance with embodiments of the current invention.

FIG. 3 illustrates one embodiment of a sequence flow of beam management procedure in accordance with embodiments of the current invention.

FIGS. 4A to 4D illustrate one embodiment of associations between the at least one RS resource and the at least one TCI state in accordance with embodiments of the current invention.

FIGS. 5A to 5D illustrate embodiments of required associations between the at least one RS resource and the at least one TCI state for the UE to apply the at least one RS resource or the at least one TCI state to downlink reception or uplink transmission in accordance with embodiments of the current invention.

FIG. 6 is a flow chart of a method of beam management in accordance with embodiments of the current invention.

### DETAILED DESCRIPTION

Reference will now be made in detail to some embodiments of the invention, examples of which are illustrated in the accompanying drawings.

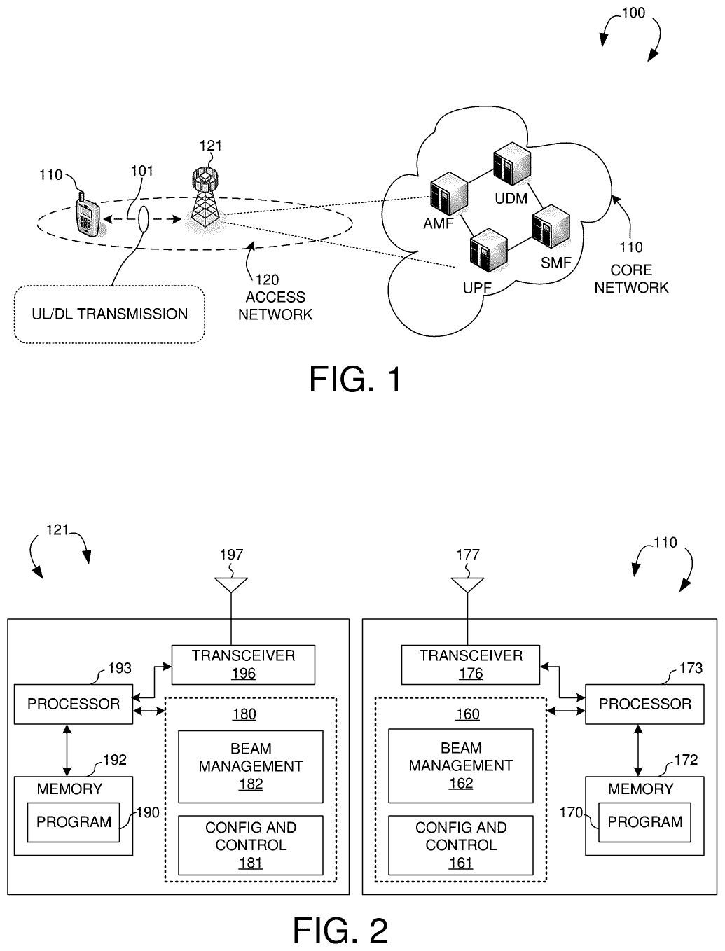

FIG. 1 illustrates an exemplary 5G new radio (NR) network 100 supporting beam management in accordance with aspects of the current invention. The 5G NR network 100 includes a user equipment (UE) 110 communicatively connected to a network node (e.g., a base station, gNB) 121 operating in a licensed band (e.g., 30 GHz˜300 GHz for mmWave) of an access network 120 which provides radio access using a Radio Access Technology (RAT) (e.g., the 5G NR technology). The access network 120 is connected to a 5G core network 130 by means of the NG interface, more specifically to a User Plane Function (UPF) by means of the NG user-plane part (NG-u), and to a Mobility Management Function (AMF) by means of the NG control-plane part (NG-c). One network node can be connected to multiple UPFs/AMFs for the purpose of load sharing and redundancy. The UE 110 may be a smart phone, a wearable device, an Internet of Things (IoT) device, and a tablet, etc. Alternatively, UE 110 may be a Notebook (NB) or Personal Computer (PC) inserted or installed with a data card which includes a modem and RF transceiver(s) to provide the functionality of wireless communication.

The network node 121 may provide communication coverage for a geographic coverage area in which communications with the UE 110 is supported via a communication link 101. The communication link 101 shown in the 5G NR network 100 may include uplink (UL) transmissions from the UE 110 to the network node 121 (e.g., on the Physical Uplink Control Channel (PUCCH) or Physical Uplink Shared Channel (PUSCH)) or downlink (DL) transmissions from the network node 121 to the UE 110 (e.g., on the Physical Downlink Control Channel (PDCCH) or Physical Downlink Shared Channel (PDSCH)).

FIG. 2 is a simplified block diagram of the network node 121 and the UE 110 in accordance with embodiments of the present invention. For the network node 121, an antenna 197 transmits and receives radio signal. A radio frequency (RF) transceiver module 196, coupled with the antenna, receives RF signals from the antenna, converts them to baseband signals and sends them to processor 193. RF transceiver 196 also converts received baseband signals from the processor 193, converts them to RF signals, and sends out to antenna 197. Processor 193 processes the received baseband signals and invokes different functional modules and circuits to perform features in the network node 121. Memory 192 stores program instructions and data 190 to control the operations of the network node 121.

Similarly, for the UE 110, antenna 177 transmits and receives RF signals. RF transceiver module 176, coupled with the antenna, receives RF signals from the antenna, converts them to baseband signals and sends them to processor 173. The RF transceiver 176 also converts received baseband signals from the processor 173, converts them to RF signals, and sends out to antenna 177. Processor 173 processes the received baseband signals and invokes different functional modules and circuits to perform features in the UE 110. Memory 172 stores program instructions and data 170 to control the operations of the UE 110.

The network node 121 and the UE 110 also include several functional modules and circuits that can be implemented and configured to perform embodiments of the present invention. In the example of FIG. 2, the network node 121 includes a set of control functional modules and circuit 180. Beam management circuit 182 handles beam management and associated network parameters for the UE 110. Configuration and control circuit 181 provides different parameters to configure and control the UE 110. The UE 110 includes a set of control functional modules and circuit 160. Beam management circuit 162 handles beam management and associated network parameters. Configuration and control circuit 161 handles configuration and control parameters from the network node 121.

Note that the different functional modules and circuits can be implemented and configured by software, firmware, hardware, and any combination thereof. The function modules and circuits, when executed by the processors 193 and 173 (e.g., via executing program codes 190 and 170), allow the network node 121 and the UE 110 to perform embodiments of the present invention.

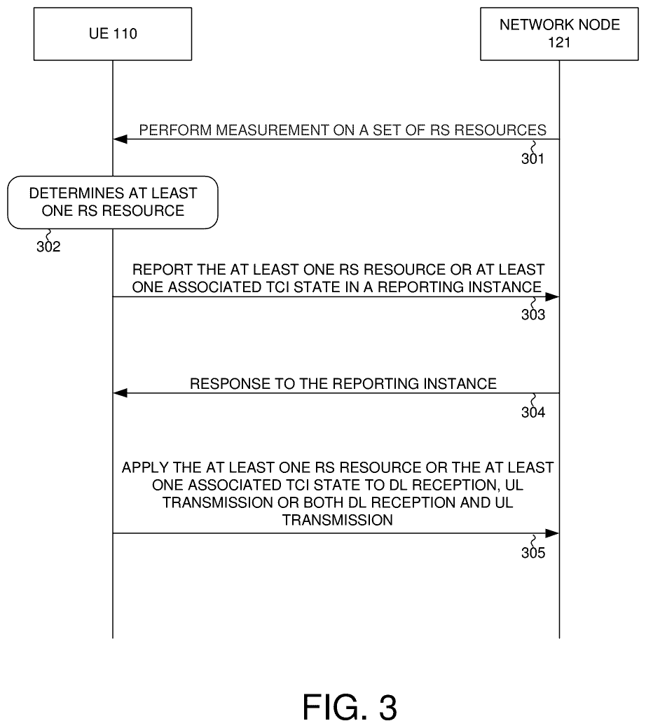

FIG. 3 illustrates one embodiment of a sequence flow of beam management procedure in accordance with one novel aspect. In particular, in step 301, the UE 110 performs measurement on a set of reference signal (RS) resources from the network node 121. The set of RS resources corresponds to a set of beams. In other words, the UE 110 performs measurement on the set of beams. Each RS resource (i.e., each beam) is associated with a transmission configuration indication (TCI) state. In some implementations, the set of RS resources is a set of synchronization signal block (SSB) resources or a set of channel state information reference signal (CSI-RS) resources.

Then, in step 302, the UE 110 determines at least one RS resource of the set of RS resources (i.e., determines at least one beam of the set of beams) for transmission (e.g., DL transmission, UL transmission or both DL and UL transmissions). The UE 110 may further record network parameter(s) (e.g., quasi-co-location (QCL) property) corresponding to the determined at least one RS resource (i.e., the determined at least one beam) in the UE 110 for later use.

Next, in step 303, the UE 110 reports the at least one RS resource (i.e., the at least one beam) or at least one TCI state associated with the at least one RS resource (i.e., the at least one beam) in a reporting instance to the network node 121.

In some implementations, the UE 110 reports the at least one RS resource (i.e., the at least one beam) by a synchronization signal block resource indicator (SSBRI) or a channel state information reference signal (CSI-RS) resource indicator (CRI) in the reporting instance.

In some implementations, the UE 110 reports the at least one TCI state in the reporting instance by at least one TCI identification of the at least one TCI state. In other words, the reporting instance may include the at least one TCI identification of the at least one TCI state.

In some implementations, a layer one reference signal received power (L1-RSRP) or layer one signal to interference noise ratio (L1-SINR) value is reported along with the at least one RS resource (i.e., the at least one beam) or along with the least one TCI state in the reporting instance.

Because the UE 110 records the network parameter(s) (e.g., QCL property) corresponding to the at least one RS resource (i.e., the at least one beam), the UE 110 may start to prepare for applying the at least one RS resource (i.e., the at least one beam) or the at least one TCI state associated with the at least one RS resource (i.e., the at least one beam) to DL reception, UL transmission or both DL reception and UL transmission without receiving any beam activation from the network node 121.

More specifically, after receiving a response from the network node 121 in response to the reporting instance in step 304, the UE 110 may directly apply the at least one RS resource (i.e., the at least one beam) or the at least one TCI state associated with the at least one RS resource (i.e., the at least one beam) to DL reception, UL transmission or both DL reception and UL transmission without receiving any beam activation from the network node 121 in step 305.

In some implementations, the response in response to the reporting instance may be a downlink control information (DCI) with an indication. In particular, the DCI may indicate a toggled value in a new beam indicator field. For example, the new beam indicator field of the previous DCI is ‘0’. When the network node 121 is aware of the reporting instance, the network node 121 transmits a DCI with the new beam indicator field ‘1’ to the UE 110.

In some implementations, the UE 110 may transmit an acknowledgement to the network node 121 in response to the response of the reporting instance, and the UE 110 may apply the at least one RS resource (i.e., the at least one beam) or the at least one TCI state associated with the at least one RS resource (i.e., the at least one beam) to DL reception, UL transmission or both DL reception and UL transmission.

In some implementations, the least one TCI state associated with the at least one RS resource may be mapped to a TCI codepoint of a DCI field by a specified rule. The specified rule may be indicated by a higher layer configuration (e.g., a radio resource control (RRC) configuration).

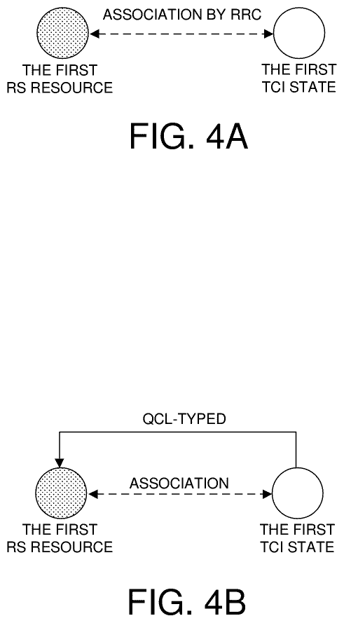

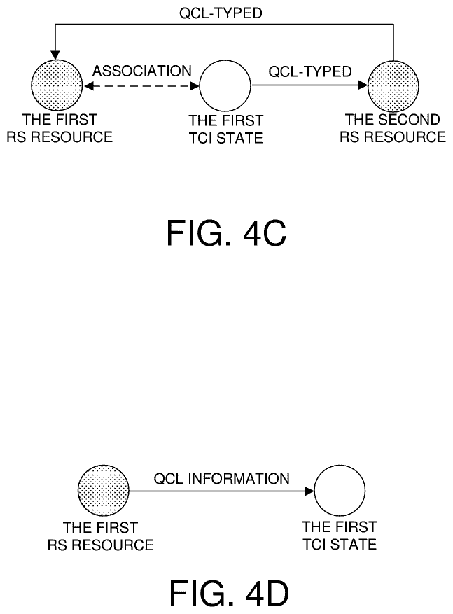

FIG. 4A illustrates one embodiment of an association between the at least one RS resource and the at least one TCI state in accordance with one novel aspect. In particular, a first TCI state of the at least one TCI state is associated with a first RS resource of the at least one RS resource (i.e., a first beam of the at least one beam) by a configuration transmitted from the network node 121. In other words, the configuration indicates the association between the first TCI state and the first RS resource (i.e., the first beam). In some implementations, the configuration may be a higher layer configuration (e.g., an RRC configuration).

FIG. 4B illustrates one embodiment of an association between the at least one RS resource and the at least one TCI state in accordance with one novel aspect. In particular, a first RS resource of the at least one RS resource is a direct spatial-QCL source RS of a first TCI state of the at least one TCI state. For example, the first RS resource is a CSI-RS directly recorded in QCL-TypeD information of the first TCI state.

FIG. 4C illustrates one embodiment of an association between the at least one RS resource and the at least one TCI state in accordance with one novel aspect. In particular, a first RS resource of the at least one RS resource is a spatial-QCL source RS of a second RS resource. The second RS resource is a spatial-QCL source RS of a first TCI state of the at least one TCI state. In other words, the first RS resource of the at least one RS resources is an indirect spatial-QCL source RS of the first TCI state of the at least one TCI state. For example, the first RS resource is an SSB corresponding to QCL-TypeD information of the second RS resource, which is a CSI-RS. The second RS resource is a CSI-RS directly recorded in QCL-TypeD information of the first TCI state.

FIG. 4D illustrates one embodiment of an association between the at least one RS resource and the at least one TCI state in accordance with one novel aspect. In particular, a first TCI state of the at least one TCI state indicates a QCL information for a first RS resource of the at least one RS resource.

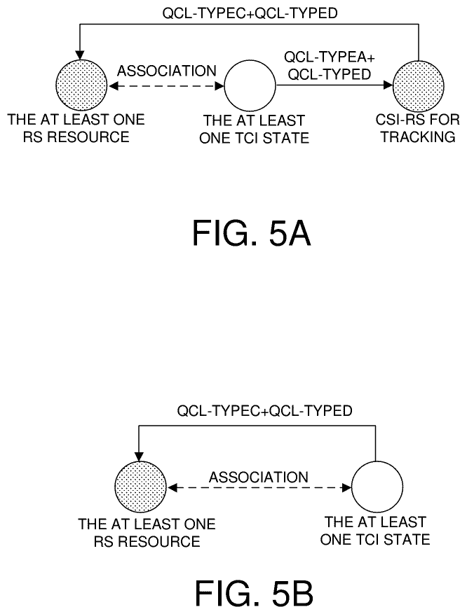

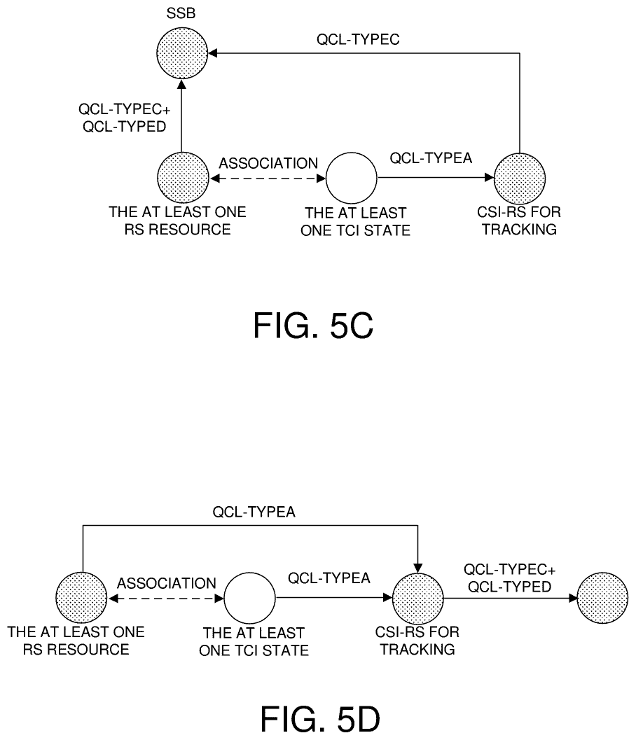

FIGS. 5A and 5B illustrate embodiments of required association between the at least one RS resource and the at least one TCI state for the UE 110 to apply the at least one RS resource (i.e., the at least one beam) or the at least one TCI state to DL reception, UL transmission or both DL reception and UL transmission in accordance with one novel aspect.

In particular, the UE 110 applies the at least one RS resource (i.e., the at least one beam) or the at least one TCI state to DL reception, UL transmission or both DL reception and UL transmission when the following requirement is fulfilled: the at least one RS resource is a direct or indirect QCL-TypeA or QCL-TypeC source RS of the least one associated TCI state.

For example, as illustrated in FIG. 5A, when the at least one RS resource is an SSB corresponding to QCL-TypeC information and QCL-TypeD information of a CSI-RS for tracking and the CSI-RS for tracking is a CSI-RS directly recorded in QCL-TypeA information and QCL-TypeD information of the at least one TCI state, the UE 110 applies the at least one RS resource (i.e., the at least one beam) or the at least one TCI state to DL reception, UL transmission or both DL reception and UL transmission.

For another example, as illustrated in FIG. 5B, when the at least one RS resource is directly recorded in QCL-TypeC information and QCL-TypeD information of the at least one TCI state, the UE 110 applies the at least one RS resource (i.e., the at least one beam) or the at least one TCI state to DL reception, UL transmission or both DL reception and UL transmission.

FIGS. 5C and 5D illustrate embodiments of required association between the at least one RS resource and the at least one TCI state for the UE 110 to apply the at least one RS resource (i.e., the at least one beam) or the at least one TCI state to DL reception, UL transmission or both DL reception and UL transmission in accordance with one novel aspect.

In particular, the UE 110 applies the at least one RS resource (i.e., the at least one beam) or the at least one TCI state to DL reception, UL transmission or both DL reception and UL transmission when the following requirement is fulfilled: a directly or indirect QCL-TypeA or QCL-TypeC source RS of the at least one RS resource is the same as a direct or indirect QCL-TypeA or QCL-TypeC source RS of the least one TCI state.

For example, as illustrated in FIG. 5C, when: (1) the at least one RS resource is a beam management CSI-RS and an SSB corresponds to QCL-TypeC information and QCL-TypeD information of the at least one RS resource; and (2) the same SSB corresponds to QCL-TypeC information of a tracking CSI-RS, which is directly recorded in QCL-TypeA information of the at least one TCI state, the UE 110 applies the at least one RS resource (i.e., the at least one beam) or the at least one TCI state to DL reception, UL transmission or both DL reception and UL transmission.

For another example, as illustrated in FIG. 5D, when: (1) the at least one RS resource is a beam management CSI-RS corresponding to QCL-TypeA information of a CSI-RS for tracking; and (2) the same tracking CSI-RS, which is directly recorded in QCL-TypeA information of the at least one TCI state, the UE 110 applies the at least one RS resource (i.e., the at least one beam) or the at least one TCI state to DL reception, UL transmission or both DL reception and UL transmission.

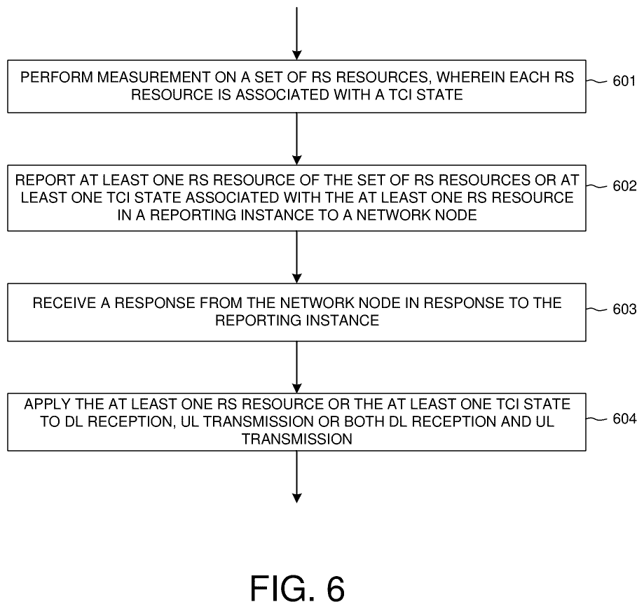

FIG. 6 is a flow chart of a method of beam management in a 5G/NR network in accordance with one novel aspect. In step 601, a UE performs measurement on a set of RS resources. Each RS resource is associated with a TCI state. In step 602, the UE reports at least one RS resource of the set of RS resources or at least one TCI state associated with the at least one RS resource in a reporting instance to a network node.

In step 603, the UE receives a response from the network node in response to the reporting instance. In step 604, the UE applies the at least one RS resource or the at least one TCI state to DL reception, UL transmission or both DL reception and UL transmission.

In some implementations, the set of RS resources corresponds to a set of beams, and the set of RS resources is a set of SSB resources or a set of CSI-RS resources.

In some implementations, the at least one TCI state is indicated in the reporting instance by at least one TCI identification. In some implementations, the at least one TCI state is mapped to at least one TCI codepoint of a DCI field by a specified rule which may be indicated in a higher layer configuration (e.g., an RRC configuration).

In some implementations, the at least one TCI state is associated with the at least one RS resource by a higher layer configuration (e.g., an RRC configuration) transmitted from the network node.

In some implementations, the at least one RS resource is a spatial-QCL source RS of the at least one TCI state. In some implementations, the at least one RS resource is a spatial-QCL source RS of another RS resource, and the another RS resource is a spatial-QCL source RS of the at least one TCI state.

In some implementations, the at least one TCI state indicates a QCL information for the at least one RS resource. In some implementations, the at least one RS resource or the at least one TCI state is applied to DL reception, UL transmission or both DL reception and UL transmission when the at least one RS resource is a direct or indirect QCL-TypeA source RS or QCL-TypeC of the least one associated TCI state. In some implementations, the at least one RS resource or the at least one TCI state is applied to DL reception, UL transmission or both DL reception and UL transmission when a directly or indirect QCL-TypeA or QCL-TypeC source RS of the at least one RS resource is the same as a direct or indirect QCL-TypeA or QCL-TypeC source RS of the least one TCI state.

In some embodiments, in an optional step (not shown), the UE may transmit an acknowledgement in response to the response of the reporting instance, and the step 604 is performed after transmitting the acknowledgement.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing, by a user equipment (UE), measurement on a set of reference signal (RS) resources, wherein each RS resource is associated with a transmission configuration indication (TCI) state;
reporting, by the UE, at least one RS resource of the set of RS resources or at least one TCI state associated with the at least one RS resource in a reporting instance to a network node;
receiving, by the UE, a response from the network node in response to the reporting instance; and
applying, by the UE, the at least one RS resource or the at least one TCI state to downlink reception or uplink transmission.

2. The method of claim 1, wherein a layer one reference signal received power or layer one signal to interference noise ratio value is reported along with the at least one RS resource or the at least one TCI state associated with the at least one RS resource in the reporting instance to the network node.

3. The method of claim 1, wherein the response is a downlink control information (DCI) transmitted from the network node.

4. The method of claim 1, wherein the at least one TCI state is mapped to at least one TCI codepoint of a downlink control information (DCI) field by a specified rule.

5. The method of claim 1, wherein the at least one TCI state is associated with the at least one RS resource by a configuration transmitted from the network node.

6. The method of claim 1, wherein the at least one RS resource is a direct or indirect spatial quasi-co-location (QCL) source RS of the at least one TCI state.

7. The method of claim 1, wherein the at least one TCI state indicates a quasi-co-location (QCL) information for the at least one RS resource.

8. The method of claim 1, further comprising:
transmitting, by the UE, an acknowledgement in response to the response, wherein the UE applies the at least one RS resource or the at least one TCI state to downlink reception or uplink transmission after the UE transmits the acknowledgement.

9. The method of claim 1, wherein the at least one RS resource or the at least one TCI state is applied to the downlink reception or uplink transmission when the at least one RS resource is a direct or indirect quasi-co-location (QCL) source RS with QCL-TypeA or QCL-TypeC of the least one associated TCI state.

10. The method of claim 1, wherein the at least one RS resource or the at least one TCI state is applied to the downlink reception or uplink transmission when the at least one RS resource and a first source RS of the least one TCI state are associated with a same second quasi-co-location (QCL) source RS resource with QCL-TypeA or QCL-TypeC.

11. A user equipment (UE) comprising:
a beam management circuit that:
performs measurement on a set of reference signal (RS) resources, wherein each RS resource is associated with a transmission configuration indication (TCI) state; and
a transceiver that:
reports at least one RS resource of the set of RS resources or at least one TCI state associated with the at least one RS resource in a reporting instance to a network node; and
receives a response from the network node in response to the reporting instance;
wherein the beam management circuit a TCI handling circuit applies the at least one RS resource or the at least one TCI state to downlink reception or uplink transmission.

12. The UE of claim 11, wherein a layer one reference signal received power or layer one signal to interference noise ratio value is reported along with the at least one RS resource or the at least one TCI state associated with the at least one RS resource in the reporting instance to the network node.

13. The UE of claim 11, wherein the response is a downlink control information (DCI) transmitted from the network node.

14. The UE of claim 11, wherein the at least one TCI state is mapped to at least one TCI codepoint of a downlink control information (DCI) field by a specified rule.

15. The UE of claim 11, wherein the at least one TCI state is associated with the at least one RS resource by a configuration transmitted from the network node.

16. The UE of claim 11, wherein the at least one RS resource is a direct or indirect spatial quasi-co-location (QCL) source RS of the at least one TCI state.

17. The UE of claim 11, wherein the at least one TCI state indicates a quasi-co-location information for the at least one RS resource.

18. The UE of claim 11, wherein the transceiver transmits an acknowledgement in response to the response, wherein the at least one RS resource or the at least one TCI state is applied to downlink reception or uplink transmission after the transmitting the acknowledgement.

19. The UE of claim 11, wherein the at least one RS resource or the at least one TCI state is applied to the downlink reception or uplink transmission when the at least one RS resource is a direct or indirect quasi-co-location (QCL) source RS with QCL-TypeA or QCL-TypeC of the least one associated TCI state.

20. The UE of claim 11, wherein the at least one RS resource or the at least one TCI state is applied to the downlink reception or uplink transmission when the at least one RS resource and a first source RS of the least one TCI state are associated with a same second quasi-co-location (QCL) source RS resource with QCL-TypeA or QCL-TypeC.
